(19) United States
(12) Patent Application Publication
(10) Pub. No.: US 2025/0096605 A1
(43) Pub. Date: Mar. 20, 2025

(54) ENERGY HARVESTING AND USE SYSTEM FOR BATTERY WITH LINEAR DISCHARGE PROFILE

(71) Applicant: HHeLi, LLC, Tulsa, OK (US)

(72) Inventor: Peter Bontorno, Tulsa, OK (US)

(21) Appl. No.: 18/891,948

(22) Filed: Sep. 20, 2024

Related U.S. Application Data
(60) Provisional application No. 63/539,523, filed on Sep. 20, 2023.

(51) Int. Cl. H02J 50/00; H01M 10/44; H01M 10/46; H02J 7/34; H02J 7/35

(52) U.S. Cl. CPC H02J 50/001; H01M 10/44; H01M 10/46; H02J 7/345; H02J 7/35

(57) ABSTRACT

Disclosed are systems and methods for charging electrochemical energy storage devices using energy harvesters. Disclosed systems and methods can employ rechargeable electrochemical energy storage devices that exhibit charging voltages that overlap with the output voltage from the energy harvester. Additionally, the electrochemical energy storage devices may exhibit monotonic voltage profiles, advantageously allowing a measured voltage of the electrochemical energy storage device to be used to instantaneously determine a state of charge of the electrochemical energy storage device. The disclosed systems also include those where the energy harvester is coupled to a rechargeable energy storage device for charging, either directly or indirectly, without using any intervening capacitors or other energy storage or voltage boosting components, increasing efficiency of the system and reducing system complexity.

### CROSS REFERENCE TO RELATED APPLICATIONS

This application claims the benefit of and priority to U.S. Provisional Application No. 63/539,523, filed on Sep. 20, 2023, which is hereby incorporated by reference in its entirety for all purposes.

### FIELD

This invention is in the field of battery technology in general, and more specifically, to a system that manages and utilizes a battery with a linear discharge profile and incorporates high-efficiency charging by environmental energy harvesting.

### BACKGROUND

U.S. Pat. No. 7,692,411 describes devices and methods for harvesting, generating, storing, and delivering energy to a load. The disclosed devices include those comprising one or more energy sources, a supercapacitor, a rechargeable battery, and a controller. The charging of the energy storage device and delivery of the power to the load is dynamically varied to maximize efficiency, with a low power consumption charge pump circuit employed to collect power from low power energy sources while enabling delivery of higher voltage power to the load. A programmable charging voltage is used to enable a wide range of applications.

### SUMMARY

Available energy harvesting systems generally employ batteries with charging voltage requirements that do not match the voltage output of the energy harvester, necessitating use of charging voltage circuitry to permit boosting of the energy harvester output voltage to match the battery's charging voltage requirements. Such boosting circuitry reduces the efficiency of the energy harvesting system, limiting their effectiveness. If the energy harvester is under sized, the system can spend time in a depleted battery condition where the circuitry powered by the energy harvesting system cannot receive adequate voltage or current for circuitry operation. In cases where the energy harvesting system is deployed for continuous data monitoring, such depleted battery conditions are undesirable. To compensate, the energy harvester may be oversized, resulting in overly complicated, excessively sized, and more expensive energy harvesting systems.

This application discloses systems and methods for charging electrochemical energy storage devices using energy harvesters, such as by employing rechargeable electrochemical energy storage devices that exhibit charging voltages that overlap with the output voltage from the energy harvester. The electrochemical energy storage devices may exhibit monotonic voltage profiles, advantageously allowing a measured voltage of the electrochemical energy storage device to be used to instantaneously determine a state of charge of the electrochemical energy storage device, which can further aid in determining whether a depleted battery condition exists or is approaching or whether the battery is near full charge. The disclosed systems also include those where the energy harvester is coupled to a rechargeable energy storage device for charging without using any intervening capacitors or other energy storage or voltage boosting components, increasing efficiency of the system and reducing system complexity.

In an aspect, the present disclosure provides systems, such as systems for harvesting environmental energy and use for charging electrochemical energy storage devices. An example system of this aspect comprises an electrochemical energy storage device having a monotonic voltage profile and rechargeability in a first voltage range; and an energy harvester that collects or is configured to collect energy from the environment and outputs a voltage in a second voltage range. In examples, the energy harvester is coupled to the electrochemical energy storage device to deliver energy collected by the energy harvester to the electrochemical energy storage device. Optionally, the first voltage range is from 0.1 V to 0.2 V, from 0.2 V to 0.3 V, from 0.3 V to 0.4 V, from 0.4 V to 0.5 V, from 0.5 V to 0.6 V, from 0.6 V to 0.7 V, from 0.7 V to 0.8 V, from 0.8 V to 0.9 V, from 0.9 V to 1.0 V, from 1.0 V to 1.1 V, from 1.1 V to 1.2 V, from 1.2 V to 1.3 V, from 1.3 V to 1.4 V, from 1.4 V to 1.5 V, from 1.5 V to 1.6 V, from 1.6 V to 1.7 V, from 1.7 V to 1.8 V, from 1.8 V to 1.9 V, from 1.9 V to 2.0 V, or any combination or subset of these ranges. Optionally, the second voltage range is from 0.1 V to 0.2 V, from 0.2 V to 0.3 V, from 0.3 V to 0.4 V, from 0.4 V to 0.5 V, from 0.5 V to 0.6 V, from 0.6 V to 0.7 V, from 0.7 V to 0.8 V, from 0.8 V to 0.9 V, from 0.9 V to 1.0 V, from 1.0 V to 1.1 V, from 1.1 V to 1.2 V, from 1.2 V to 1.3 V, from 1.3 V to 1.4 V, from 1.4 V to 1.5 V, from 1.5 V to 1.6 V, from 1.6 V to 1.7 V, from 1.7 V to 1.8 V, from 1.8 V to 1.9 V, from 1.9 V to 2.0 V, or any combination or subset of these ranges. Optionally, the voltage output by the energy harvester is less than 1.0 V, less than 0.95 V, less than 0.9 V, less than 0.85 V, less than 0.8 V, less than 0.75 V, less than 0.7 V, less than 0.65 V, less than 0.6 V, less than 0.55 V, or less than 0.5 V. Optionally, the voltage output by the energy harvester is from 0.3 V to 1.5 V or from 0.3 V to 1.0 V.

Suitable energy harvesters can be used with the systems described herein, such as those that obtain, convert, or otherwise generate electrical energy from an environmental source, as opposed to drawing energy from a conventional power source, such as a battery, AC mains or AC/DC transformer, etc. In examples, the energy harvester comprises one or more of a photocell, a photovoltaic cell, a piezoelectric generator, an electromechanical generator, a thermoelectric generator, a pyroelectric generator, a field inductance transducer, a sound transducer, a pressure transducer, or other transducer capable of generating electrical energy from environmental conditions.

In examples, the energy harvester is directly coupled to the electrochemical energy storage device. Optionally, other configurations are possible. In some examples, it is desirable to limit certain components from being positioned between the electrochemical energy storage device and the energy harvester, such as to avoid complexity or components that are power or energy inefficient or would limit the ability to capture energy collected by the energy harvesting device and forward it to the electrochemical energy storage device. Optionally, the energy harvester is coupled to the electrochemical energy storage device without any capacitor or voltage boosting circuitry between the energy harvester and the electrochemical energy storage device. Optionally, the energy harvester does not include any capacitor or voltage boosting circuitry. Optionally, the energy harvester is coupled to the electrochemical energy storage device without any circuit component or device that includes a capacitor between the energy harvester and the electrochemical energy storage device. In these and other examples, the energy harvester may optionally be indirectly coupled to the electrochemical energy storage device using one or more intervening circuit components.

Suitable electrochemical energy storage devices may be used with the systems described herein. Optionally, the electrochemical energy storage device comprises a pseudocapacitor, super capacitor, ultra capacitor, or double-layer capacitor. Optionally, the electrochemical energy storage device comprises an electrochemical cell or battery. In some examples, the electrochemical energy storage device does not exhibit a voltage plateau anywhere in the first voltage range. In some examples, the electrochemical energy storage may exhibit a voltage plateau in the first voltage range (e.g., from 0.1 V to 2 V or from 0.3 V to 1.5 V), though such a system may not exhibit all the advantages of a system where the electrochemical energy storage does not exhibit a voltage plateau. Optionally, the voltage output by the energy harvester may be less than a nominal or maximum voltage of the electrochemical energy storage device when fully charged. For example, the first voltage range may be greater than the second voltage range or have or include voltages with magnitudes greater than voltages in the second voltage range. In some examples, the voltage output by the energy harvester has a magnitude capable of charging, or is sufficient to charge, the electrochemical energy storage device to less than 100% state of charge, such as to no more than 75% state of charge, to no more than 50% state of charge, to no more than 25% state of charge, or to no more than 10% state of charge. In one example, the electrochemical energy storage device may comprise a lithium-ion battery or cell, exhibiting a first rechargeability voltage in a range of about 3.0 V to about 4.2 V and also exhibiting a second rechargeability voltage in a range of about 0.3 V to about 1.5 V.

In examples where the electrochemical energy storage device comprises a battery or an electrochemical cell such battery or electrochemical cell may comprise a surface-functionalized acidified metal oxide nanomaterial, for example as a component of an anode electrode or a cathode electrode, such as a cathode active material or an anode active material of the battery. Optionally, an anode active material of the electrochemical cell or battery comprises lithium metal, graphite, silicon, or a combination of these.

Other components may be included in the systems described herein. For example, systems of this aspect may comprise or further comprise one or more components coupled to the electrochemical energy storage device, such as one or more of a voltage converter that generates an output voltage using a voltage of electrochemical energy storage device as an input, a processor or other logic device, a limiting circuit, an output capacitor for stabilizing the output voltage, a standby load, a switch, or an output load. Optionally, a voltage converter may be a boost converter exhibiting an input operating voltage in the first voltage range (e.g., from 0.1 V to 2.0 V or from 0.3 V to 1.5 V). Optionally, a standby load corresponds to or comprises a continuously active circuit, a sensor, a monitoring circuit, a feedback circuit, a control circuit, a clock circuit or function, a processor or processing function, or any combination of these. Optionally, an output load corresponds to or comprises a periodically active or discontinuously active circuit, a wireless transmitter, a wireless transceiver, a wireless receiver, or any combination of these. In some examples, the output load, when active, exhibits a larger power consumption than the standby load.

In some examples, it may be desirable to limit or prevent overcharging of the electrochemical energy storage device by the energy harvester, such as if the energy harvester is not properly sized or generates or is capable of generating a voltage greater than a maximum charge voltage for the electrochemical energy storage device, so limiting circuits may be optionally used in the disclosed systems. For example, the energy harvester may optionally comprise a limiting circuit. Optionally, the system may comprise or further comprise a limiting circuit, such as positioned between the energy harvester and the electrochemical energy storage device. In examples, the limiting circuit may include one or more components for limiting the voltage output by the energy harvester. In examples, the limiting circuit may include one or more components for preventing the energy harvester from overcharging the electrochemical energy storage device.

Other configurations may be used to prevent or limit the energy harvester from overcharging the electrochemical energy storage device. Optionally, the energy harvester is sized with a capacity that does not exceed 100% of any standby load and any transmission load in the system together. Optionally, an output load may be configured to be active on a repeated basis to avoid overcharging the electrochemical energy storage device.

In another aspect, methods are described herein, such as methods for operating the systems described herein or methods for operating energy harvesting devices and/or for charging electrochemical energy storage devices. In an example, a method of this aspect comprises collecting energy using an energy harvester, wherein the energy harvester outputs a voltage in a second voltage range (e.g., from 0.1 to 2 V or from 0.3 V to 1.5 V); and charging an electrochemical energy storage device using energy collected by the energy harvester. Optionally, the electrochemical energy storage device exhibits a monotonic voltage profile and rechargeability in a first voltage range (e.g., from 0.1 V to 2 V or from 0.3 V to 1.5 V). In examples, methods of this aspect may correspond to methods of operating any of the systems described herein.

Without wishing to be bound by any particular theory, there can be discussion herein of beliefs or understandings of underlying principles relating to the invention. It is recognized that regardless of the ultimate correctness of any mechanistic explanation or hypothesis, an embodiment of the invention can nonetheless be operative and useful.

### BRIEF DESCRIPTION OF THE DRAWINGS

FIG. 1 provides a schematic illustration of an energy harvesting system including a charging circuit.

FIG. 2 provides a schematic illustration of a system including an energy harvester and an electrochemical energy storage device having a monotonic voltage discharge profile.

FIG. 3 provides an example of discharge curve mapped to state of charge for a battery having a monotonic voltage discharge profile and rechargeability in a voltage range of 0.3 V to 1.5 V.

FIG. 4 provides an example of charge curve mapped to state of charge for a battery having a monotonic voltage charge profile and rechargeability in a voltage range of 0.3 V to 1.5 V.

FIG. 5 provides a schematic circuit diagram for an example energy harvester system.

FIG. 6 provides data showing measured voltages during operation of an example energy harvester system.

FIG. 7 provides data showing measured currents during operation of an example energy harvester system.

### DETAILED DESCRIPTION

Described are systems and methods for charging electrochemical energy storage devices using energy harvesters. The described systems and methods can employ rechargeable electrochemical energy storage devices that exhibit monotonic voltage profiles, advantageously allowing a measured voltage of the electrochemical energy storage device to be used to instantaneously determine a state of charge of the electrochemical energy storage device. Such electrochemical energy storage devices contrast with other rechargeable devices, such as lithium-ion and nickel-cadmium batteries, where the devices exhibit a voltage plateau. In the case of a lithium-ion battery, such batteries tend to exhibit a voltage plateau in the range of about 70% state of charge to about 30% state of charge, where the discharge of the battery does not result in a significant change in the voltage of the battery, meaning that the battery voltage does not immediately reflect the state of charge of the battery. This voltage plateau is generally considered an advantageous feature of lithium-ion and nickel-cadmium batteries, since the battery provides a relatively stable voltage output over most of its operation and once the voltage dips significantly below the voltage plateau the battery is considered depleted and ready for recharging.

The rechargeable electrochemical energy storage devices used in the systems described herein exhibit rechargeability in a voltage range of from 0.3 V to 1.5 V, which can match the voltage output of many energy harvesters but may be lower than typical lithium-ion battery voltage ranges. In this such way, an energy harvester can be directly coupled to a rechargeable energy storage device to charge the device without the need for any intervening capacitors or other storage or voltage boosting components. Such systems contrast with prior energy harvesting systems where larger charging voltages are needed for charging a battery, like a lead-acid (e.g., about 2.5 V per cell) or lithium-ion battery (about 4.2 V per cell), and so charging circuitry, storage capacitors, and voltage boosting circuitry is used in these prior systems. Eliminating use of capacitors or other storage or voltage boosting components between the energy harvester and the energy storage device, as used in the systems and methods described herein, can result in improved efficiency as compared to prior energy harvesting systems, as the charging circuitry, storage capacitors, and voltage boosting circuitry can consume significant amounts of the harvested energy before it is directed to the battery. The improved efficiency of the disclosed systems and methods allows for smaller sized systems and more robust use in low-power applications, such as Internet-of-things type devices, smart sensors, or the like, allowing for improved longevity of use without application of external charging or replacing battery cells.

In general, the terms and phrases used herein have their art-recognized meaning, which can be found by reference to standard texts, journal references and contexts known to those skilled in the art. The following definitions are provided to clarify their specific use in the context of the invention.

“Electrochemical energy storage device” refers to a device that can store electrical energy electrochemically, such as by way of movement of ions between electrodes in one direction during charging. Examples of electrochemical energy storage devices include electrochemical cells, batteries, pseudocapacitors, super capacitors, ultra capacitors, or double-layer capacitors.

“Energy harvester” refers to a device or component that derives energy from external sources, usually passive ambient environmental sources such as solar energy, thermal energy, wind energy, radio or electromagnetic wave energy, etc., and outputs a voltage for use by other devices or components. The term “energy harvester” generally excludes components or devices that draw power from an energy storage device, like a battery, or a switching power supply or transformer deriving energy from mains or AC power (e.g., 100-240 V AC power at 50-60 Hz provided by an electric grid or DC inverter). The energy harvesters useful with aspects described herein include those outputting voltages in a particular voltage range, such as the range of 0.1 V to 2.0 V or 0.3 V to 1.5 V.

“Monotonic voltage profile” refers to the shape of a charge and/or discharge curve of an electrochemical energy storage device that continually decreases as a function of state of charge during discharge or continually increases as a function of state of charge during charge, such as without exhibiting any voltage plateau where the voltage does not change significantly as a function of state of charge. Due to this feature, the state of charge of energy storage devices exhibiting monotonic voltage profiles can generally be instantaneously derived from the voltage of the energy storage device, such as by application of a correction factor, use of a lookup table, or evaluation using an analytical formula, and without use of complicated monitoring of active coulomb counting, which is typically used in state of charge estimation methods when batteries exhibiting a voltage plateau are used.

“Voltage plateau” refers to a relatively flat region of the discharge curve of an electrochemical energy storage device where the voltage does not appreciably change as a function of state of charge of the energy storage device. Examples of electrochemical energy storage devices that exhibit a voltage plateau include conventional lithium-ion batteries, where a voltage plateau at about 3.6 V to about 3.7 V may occur between about 70% state of charge and about 30% state of charge, and other batteries, such as Ni—Cd and NiMH batteries.

“Surface-functionalized acidified metal oxide nanomaterial” refers to a battery material comprising a plurality of particles of a metal oxide material with a cross-sectional dimension less than 1 μm, 500 nm, or 100 nm, including surface functional groups (e.g., Cl, Br, I, F, SO₄, NO₃, PO₄, BO3, CN, CH₃COO, etc.), and exhibiting an acidic character, such as characterized by a pH less than 7 when suspended in water at 5 wt. %. Surface-functionalized acidified metal oxide nanomaterials and related devices and techniques are described, for example, in U.S. Pat. Nos. 9,786,910, 10,553,861, 10,566,620, 10,700,349, 10,978,731, 11,165,090, 11,641,014, and 12,087,901, which are hereby incorporated by reference.

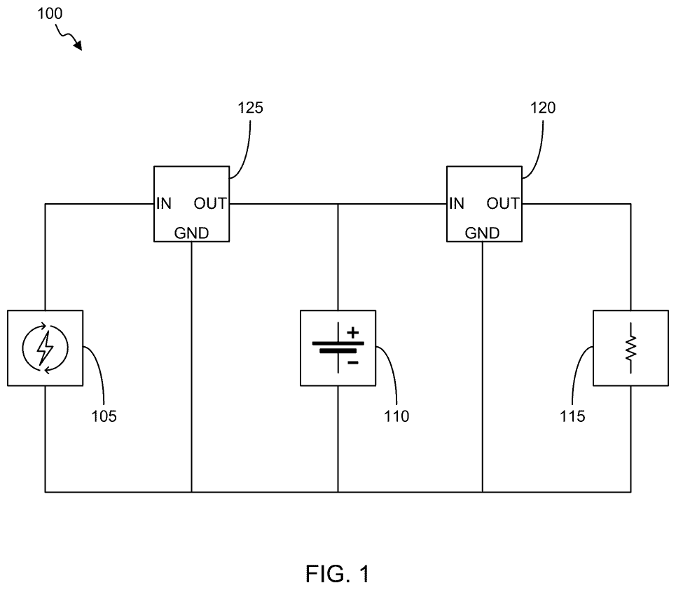

FIG. 1 provides an overview of an example energy harvesting system 100. Such energy harvester system 100 may correspond to a system that does not include several elements, limitations, or features of the systems described and claimed herein, and may include other elements, limitations, or features that are explicitly removed, absent, or otherwise missing or eliminated from the systems described and claimed herein. Energy harvesting system 100 is shown to illustrate general operational principles of some energy harvesting systems and is not intended to be limiting.

Energy harvesting system 100 includes an energy harvester 105, a battery 110, a load 115, a voltage controller 120, and a charge controller 125. In operation, energy harvester 105 generates a voltage that is insufficient for charging battery 110, and so charge controller 125 is used to boost the voltage to a level that can charge battery 110. Charge controller 125 generally includes one or more capacitors or other temporary energy storage elements that are used to gather sufficient energy from the energy harvester 105 in order to boost the output voltage to a level sufficient for charging battery 110. While such a system including a charge controller 125 can be useful, the energy efficiency of the system is reduced due to the losses that can occur when boosting the output voltage in charge controller 125, allowing a considerable amount of the energy captured by the energy harvester 105 to be lost (e.g., to heat) or otherwise not be useful for charging the battery 110.

In turn, battery 110 may exhibit an output voltage that is not optimal or suited for use by load 115, and so voltage controller 120 is used to adjust the battery voltage to a magnitude useful for load 115. Voltage controller 120 can be used to reduce (buck) the battery voltage down, or raise (boost) the battery voltage up, to a level suitable for load 115. Although the use of voltage controller 120 can be similarly inefficient as charge controller 125, voltage controller 120 may still be useful for ensuring that the voltage requirements of load 115 can be met using battery 110.

Typically, the battery 110 in energy harvesting system 100 may be a rechargeable battery, commonly a lithium-ion battery, such as exhibiting a voltage profile and rechargeability in the range of about 3 V to about 4 V, and exhibiting a voltage plateau at about 3.5 V, such as about 3.4 V to about 3.6 V or 3.7 V. For such an energy harvesting system 100, it is generally desirable for energy harvester to be as large as possible and provide as high of an output voltage as possible to maximize the power available to the load 115 and to charge battery 110 by way of charge controller 125.

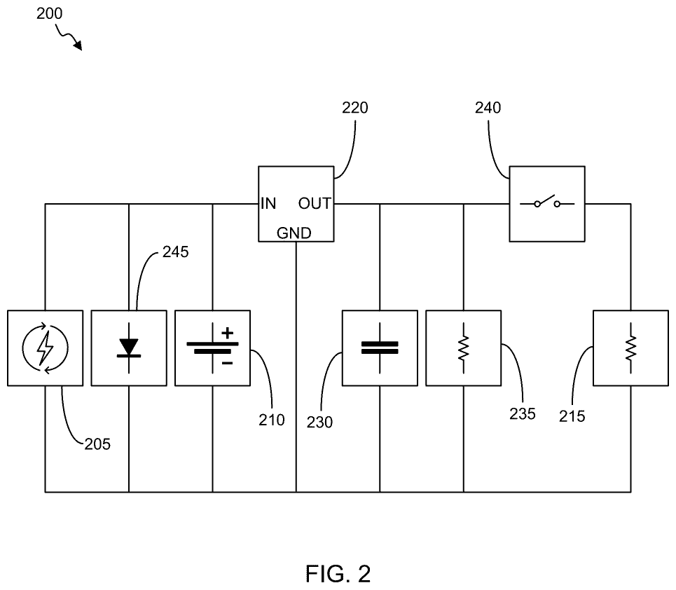

In contrast, the systems described herein can employ a scheme where a charge controller or other components including temporary storage elements, like capacitors, are not used between the energy harvester and the primary energy storage component. FIG. 2 illustrates an example system 200 including an energy harvester 205, an electrochemical energy storage device 210, a load 215, and a voltage controller 220, which may be comparable to energy harvester 105, battery 110, load 115, and voltage controller 120 described with reference to FIG. 1, but these elements may also be different. In FIG. 2, voltage controller 220 is optional, and may not be present for all embodiments and examples, and load 215 may be coupled to electrochemical energy storage device 210, either directly or indirectly, without use of any voltage controller, such as when the voltage requirements of load 215 sufficiently match the voltage outputs of electrochemical energy storage device 210.

FIG. 2 also shows some other optional components useful with some examples or embodiments. For example, FIG. 2 shows that system 200 may include one or more of a capacitor 230, an additional load 235, switching circuitry 240, and/or a limiting circuit 245. Again, these components are optional and may not be used by all embodiments or examples. These optional components may be representative of common components that could be beneficial for various examples and embodiments and are described below in further detail. Additionally, other components or circuitry may be present as part of system 200 or electrically coupled to system 200. For example, microprocessors or other logic devices may be incorporated into system 200, such as to power such microprocessors or other logic devices using energy from the energy harvester 205 and/or electrochemical energy storage device 210.

For example, capacitor 230 can be useful for ensuring that the voltage output by electrochemical energy storage device 210 or voltage controller 220 is stabilized, such as during high power draw by load 215, or to provide filtering, smoothing, or other shaping to the output of electrochemical energy storage device 210 or voltage controller 220. Other circuit elements, such as inductors, resistors, or other shaping, filtering, or smoothing circuitry can be optionally used in addition to or in place of capacitor 230. Other circuit components may also be used. In some examples, a capacitor, inductor, or other filtering, smoothing, stabilizing, or shaping circuitry may be incorporated directly into voltage controller 220 so as to enhance the operation of voltage controller 220 or to minimize the complexity of other elements of system 200.

Additional load 235 may be present or useful when load 215 is using the harvested and stored energy from energy harvester 205 and electrochemical energy storage device 205, but additional features are still desired, such as when additional load 235 uses smaller currents or energy or power draws than load 215. In some examples, load 215 may correspond to a higher energy, power, or current usage component than additional load 235. Load 215 and additional load 235 may generally correspond to any suitable device, circuitry, or system for which use of the harvested and stored energy from energy harvester 205 and electrochemical energy storage device 205 is desired.

Together, or independently, load 215 and additional load 235 may correspond to an internet-of-things device, such as including one or more sensors, one or more processors, one or more wireless transceivers, and/or the like. In a specific example, additional load 235 may correspond to or comprise one or more sensors, such as may be operating continuously (e.g., to collect environmental or other information), while load 215 may correspond to or comprise a radio transmitter or transceiver which may periodically activate to transmit data corresponding to the collected sensor information or other data. In this example, sensor(s) corresponding to additional load 235 may be lower-power components, while the transmitter or transceiver corresponding to load 215 may be a higher-power component. In some examples, load 215 may be referred to as an output load, while additional load 235 may be referred to as a standby load. Useful output loads include, but are not limited to, a periodically active or discontinuously active circuit, a wireless transmitter, a wireless transceiver, or a processor in an active state, or a combination of such loads. Useful standby loads include, but are not limited to, a continuously active circuit, a sensor, a monitoring circuit, a control circuit, a clock function or circuit, a feedback circuit, a processor or processing function in an inactive state, or a combination of such loads. In some examples, a processor in an active state or other active processing function may be, correspond to, or comprise a component of a standby load.

Switching circuitry 240 is shown to illustrate that load 215 may optionally not be a continuously operating component and may be switched on or activated on a repeated, periodic, or aperiodic basis, such as when conditions or needs dictate or when otherwise desirable. In the example where load 215 corresponds to a radio transmitter, switching circuitry 240 can correspond to components that activate the radio transmitter, such as on a periodic basis. Switching circuitry 240 may correspond to a physical component, such as a switch, relay, transistor, etc., or other component or configuration for activating passage of current to load 215 or can otherwise generally represent switchable activation of load 215, without limitation, in contrast with additional load 235, which is shown in a configuration where voltage/current from the electrochemical energy storage device is always present at additional load 235, indicating additional load 235 is in an ‘always active’ state. Such a configuration is merely provided for purposes of illustration, however, and is not intended to be limiting, such that additional load 235 may also be in a switchable configuration, similar to, but optionally independent from, load 215. Optionally, load 215 may be activated on a repeated basis to prevent energy harvester 205 from overcharging electrochemical energy storage device 210.

Electrochemical energy storage device 210 may correspond to any suitable energy storage device, for example an electrochemical energy storage device exhibiting a monotonic voltage profile, such as some types of electrochemical cells, batteries, pseudocapacitors, super capacitors, ultra capacitors, double-layer capacitors, or the like. The use of electrochemical energy storage device 210 exhibiting a monotonic voltage profile can allow for direct determination of a state of charge of the electrochemical energy storage device 210 based on a voltage of the electrochemical energy storage device 210. In some examples, a lookup table, analytical formula, or correction factor can be used with the voltage to directly determine a state of charge of the electrochemical energy storage device 210, such as without using or resorting to complicated coulomb counting techniques, which are commonly used in other state of charge estimation techniques. In this way, a system can immediately identify its state of charge, which can then be used to trigger other events or activities. For example, in the case of a low state of charge, a notification can be sent to a user, one or more standby loads can be optionally deactivated, or other actions can be taken to reduce the power draw. As another example, in the case of a high-state-of charge, a notification can be sent to a user, one or more standby or output loads can be optionally activated, or other actions take to utilize available energy and/or prevent overcharging of the electrochemical energy storage device 210. The example of electrochemical energy storage device 210 exhibiting a monotonic voltage profile is not intended to be limiting, however, and electrochemical energy storage devices that do not exhibit a monotonic voltage profile or that exhibit a voltage plateau are optional features of the systems described herein, though such devices may not directly allow for determination of a state of charge directly from the voltage. As examples, electrochemical energy storage devices with charging ranges that overlap an output voltage of the energy harvester 205 can be used.

In a specific example, electrochemical energy storage device 210 is an electrochemical cell or a battery, such as comprising one or more individual electrochemical cells. Useful batteries include those comprising a surface-functionalized acidified metal oxide nanomaterial as a cathode or anode component or active material. Surface-functionalized acidified metal oxide nanomaterials may be advantageous for use as a cathode component or active material. The surface-functionalized acidified metal oxide nanomaterial can be paired with any suitable anode, such as an anode including lithium metal, graphite, silicon, or a combination of these or other anode active materials. Batteries constructed using a surface-functionalized acidified metal oxide nanomaterial as a cathode active material may be particularly useful, as these batteries can exhibit a monotonic voltage profile and rechargeability voltage range desired for some applications and may thus be desirably suited for pairing with an energy harvester, as described herein.

In some examples, electrochemical energy storage device 210 exhibits rechargeability in a first voltage range. Optionally, the electrochemical energy storage device 210 may exhibit rechargeability in a range from about 0.1 V to about 2.0 V or from about 0.3 V to about 1.5 V, but in some cases rechargeability may extend above these ranges, depending on the chemistry or structure of electrochemical energy storage device 210. In some examples, a specified rechargeability may correspond to a target range for which rechargeability is used; for example, a battery that has a nominal full rechargeability capacity to 3.5 V or 4.2 V may be used with an energy harvester at a lower voltage range, such as 0.3 V to 1.5 V, which may still be in the rechargeability range of the battery despite being significantly lower than a nominal or full rechargeability voltage for the battery.

In some examples, the electrochemical energy storage device 210 exhibits rechargeability in a range from 0.1 V to 0.2 V, from 0.2 V to 0.3 V, from 0.3 V to 0.4 V, from 0.4 V to 0.5 V, from 0.5 V to 0.6 V, from 0.6 V to 0.7 V, from 0.7 V to 0.8 V, from 0.8 V to 0.9 V, from 0.9 V to 1.0 V, from 1.0 V to 1.1 V, from 1.1 V to 1.2 V, from 1.2 V to 1.3 V, from 1.3 V to 1.4 V, from 1.4 V to 1.5 V, from 1.5 V to 1.6 V, from 1.6 V to 1.7 V, from 1.7 V to 1.8 V, from 1.8 V to 1.9 V, from 1.9 V to 2.0 V, or to any combination or subset of these ranges. In a specific example, the electrochemical energy storage exhibits rechargeability in a range from 0.3 V to 1.5 V or from 0.3 V to 1.0 V.

In FIG. 2, energy harvester 205 may correspond to any suitable energy harvester. Examples of suitable energy harvesters include, but are not limited to, photocell, a photovoltaic cell, a piezoelectric generator, an electromechanical generator, a thermoelectric generator, a pyroelectric generator, a field inductance transducer, a sound transducer, a pressure transducer, or other transducer capable of generating electrical energy from environmental conditions (e.g., a shape memory alloy thermal energy to electrical energy transducer). In some examples, energy harvester 205 does not include any charge controllers, or capacitors, voltage boosters, and/or other temporary energy storage components that may be present in a charge controller for raising the voltage generated by energy harvester 205 to a larger voltage suitable for charging electrochemical energy storage device 210. In some examples, energy harvester 205 collects or is configured to collect energy from the environment and output a voltage in a second voltage range, which may be the same as or different from a first voltage range for which the electrochemical energy storage device exhibits rechargeability. In general, it may be desirable for energy harvester 205 to exhibit a voltage output that matches or falls below or within the range of voltages suitable for charging electrochemical energy storage device 205, but this may not always be the case for every example or embodiment. Optionally, energy harvester 205 may output a voltage in a range from about 0.1 V to about 2.0 V or from about 0.3 V to about 1.5 V. The voltage output by the energy harvester 205 may have a magnitude capable of charging or sufficient to charge the electrochemical energy storage device to less than 100% state of charge, such as to no more than 75% state of charge, to no more than 50% state of charge, to no more than 25% state of charge, to no more than 10% state of charge.

In some cases, the output voltage range of energy harvester 205 may extend above the target rechargeability range for electrochemical cell 210, depending on the structure of energy harvester 205 or the amount of or the rate at which of energy is collected by energy harvester 205. Optionally, system 200 may include a limiting circuit 245 (e.g., a passive limiting circuit), such as components that serve to reduce or limit the voltage output of energy harvester 205 to a particular voltage range. Limiting circuit 245 may optionally be a component of energy harvester 205. As an example, system 200 may comprise a diode (e.g., a Schottky or other diode), which may optionally be wired in parallel with the electrochemical energy storage device 210 and/or energy harvester 205 to maintain the voltage received at the electrochemical energy storage device 210 below a forward threshold voltage associated with the diode. Use of a diode in this way can be advantageous as such an element is a passive element that consumes very little energy when it is not actively limiting the voltage received at the electrochemical energy storage device 210, providing for an energy-efficient mechanism for ensuring that the electrochemical energy storage device 210 is not overcharged or subjected to a charging voltage in excess of a safe, nominal, or otherwise desirable voltage.

In some examples, energy harvester 205 provides an output voltage in a range from 0.1 V to 0.2 V, from 0.2 V to 0.3 V, from 0.3 V to 0.4 V, from 0.4 V to 0.5 V, from 0.5 V to 0.6 V, from 0.6 V to 0.7 V, from 0.7 V to 0.8 V, from 0.8 V to 0.9 V, from 0.9 V to 1.0 V, from 1.0 V to 1.1 V, from 1.1 V to 1.2 V, from 1.2 V to 1.3 V, from 1.3 V to 1.4 V, from 1.4 V to 1.5 V, from 1.5 V to 1.6 V, from 1.6 V to 1.7 V, from 1.7 V to 1.8 V, from 1.8 V to 1.9 V, from 1.9 V to 2.0 V, or to any combination or subset of these ranges. In specific examples, energy harvester 205 exhibits or is configured to exhibit an output voltage in a range from 0.3 V to 1.5 V, from 0.3 V to 1.0 V, with a maximum voltage of 1.0 V (e.g., less than 1.0 V), with a maximum voltage of 0.75 V (e.g., less than 0.75 V), or with a maximum voltage of 0.5 V (e.g., less than 0.5 V). In examples where limiting circuit 245 is used, energy harvester 205 may exhibit or be configured to exhibit a higher output voltage than 2.0 V.

As illustrated in FIG. 2, the energy harvester 205 may be directly coupled to the electrochemical energy storage device 210, such as without any intervening circuit components or elements. In some examples, however, the energy harvester 205 may be indirectly coupled to the electrochemical energy storage device 210, such as where one or more intervening circuit components or elements are electrically coupled between the energy harvester 205 and the electrochemical energy storage device 210. As noted above, in some examples, a diode may be positioned as a voltage limiter between the energy harvester 205 and the electrochemical energy storage device 210. Other configurations are possible. The invention may be further understood by the following non-limiting examples.

### Example 1: Conversion Between Voltage and State of Charge for a Battery Cell with a Monotonic Voltage Profile

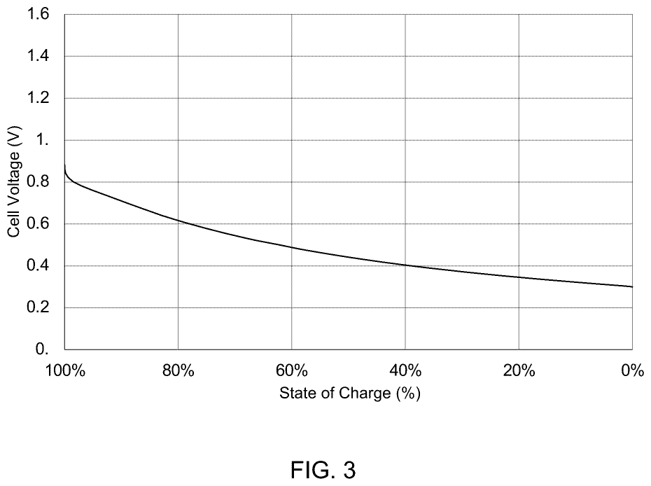

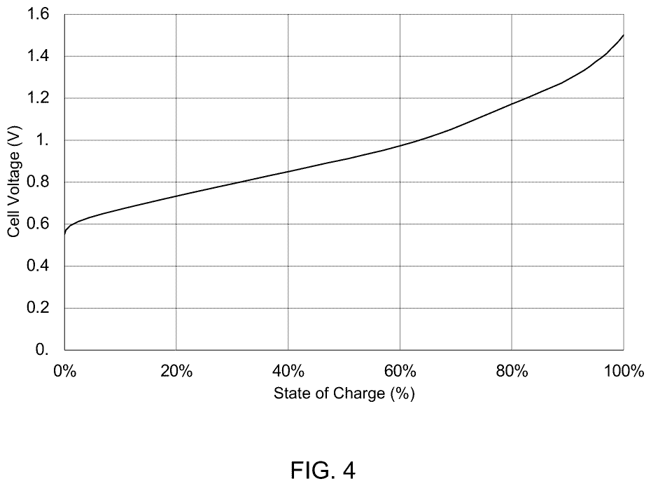

Test battery cells having a monotonic voltage profile were constructed and subjected to cell cycling. For these batteries, a surface-functionalized acidified metal oxide nanomaterial was used as a cathode active material and lithium metal was used as the anode active material and the cells were constructed as 2032 format coin cells. The batteries were cycled by discharging to 0.3 V using a discharge current of 1 mA, followed by charging to 1.5 V using a charging current of 1 mA and the capacity measured as a function of voltage. The measured capacity was converted to state of charge by defining 0% state of charge at a voltage of 0.3 V during discharge and 100% state of charge at a voltage of 1.5 V during charging. It will be appreciated that the differences between state of charge at voltages during charging/discharging may be characterized as polarization of the battery. FIG. 3 provides a reference state of charge vs. voltage curve for discharging. FIG. 4 provides a reference state of charge vs. voltage curve for charging. FIG. 3 shows the monotonic discharge profile of the batteries, exhibiting no voltage plateaus between 1.5 V and 0.3 V. FIG. 4 shows the monotonic charge profile of the batteries, exhibiting no voltage plateaus between 0.3 V and 1.5 V. Using the data collected, a state of charge of the battery, either during charging or during discharging, can be determined by measuring the voltage of the battery and then, for example, using a look-up-table to evaluate the corresponding state of charge.

Additional details about batteries including sloping discharge profiles are disclosed in U.S. Patent Application Publication No. 2024/0097478, which is hereby incorporated by reference.

### Example 2: Energy Harvesting Test System

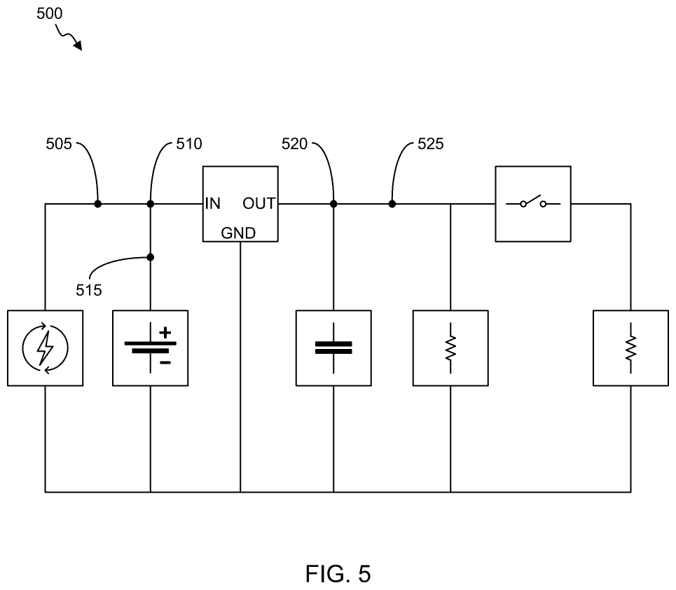

An example energy harvesting system was constructed and a schematic circuit diagram 500 is shown for this system in FIG. 5. The system is constructed similar to system 200 shown in FIG. 2, and includes an energy harvester, a battery, a voltage controller, a capacitor, a standby load, and a switchable transmission load. A small solar cell was used as the energy harvester. One of the 2032 format coin cells as described in Example 1 was used as the battery. A commercially available boost converter with a 3.3 V nominal output was used for the voltage controller. Resistors were used as the loads to permit switching between a high load (output load) and low load (standby load) conditions.

Currents and voltages were monitored during operation of the energy harvesting system as follows. The current output by the energy harvester was probed at position 505, between the energy harvester and the junction with the battery/boost converter. The voltage of the battery was monitored at position 510, corresponding to the junction between the battery, the energy harvester, and the boost converter. Current to/from the battery was monitored at position 515, between the battery and the junction with the energy harvester/boost converter. Voltage output from the boost converter (load voltage) was monitored at position 520 and current to the loads was monitored at position 525.

Lighting conditions were adjusted to provide harvesting of energy from the solar cell into the battery without the output load active. The system was operated while monitoring the voltages and currents as noted above and the output load was cycled active for a short duration to determine current flows and voltages prior to the active cycle, during the active cycle, and following the active cycle.

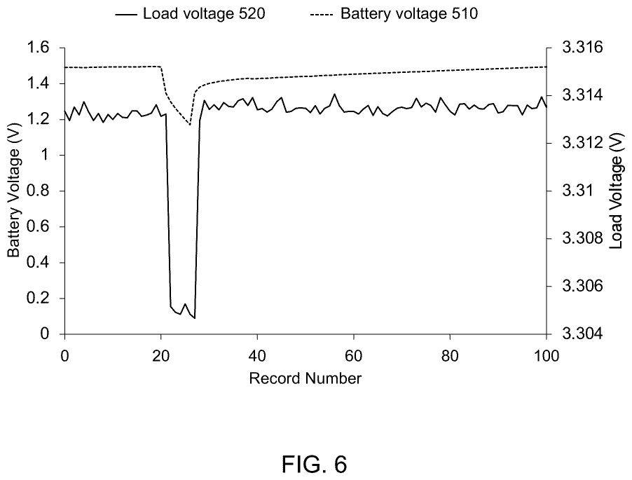

FIG. 6 provides voltage data showing the battery voltage measured at position 510 (left axis) and the load voltage measured at position 520 (right axis). The output load was activated between record numbers 20 and 21, and the load voltage dropped from about 3.314 V to about 3.305 V. Simultaneously, the battery voltage began to decline from about 1.5 V and reached a minimum at about 1.2 V before the active cycle was completed. After completion of the active cycle, the load voltage returned to its previous value, while the battery voltage rose back towards its original value of about 1.5 V by around record number 100.

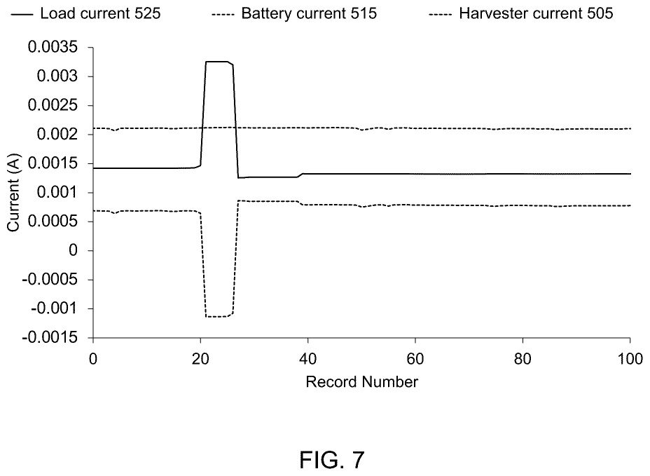

FIG. 7 provides current data showing the current from the energy harvester measured at position 505, the current to/from the battery measured at position 515, and the current to the load measured at position 525. The harvester current remained constant prior to, during, and after activation of the load at just over 2 mA. The current to the load jumped from just under 1.5 mA to just over 3 mA during activation of the output load and returned to under 1.5 mA after the active cycle was completed. The battery current prior to the active cycle was just over 0.5 mA, indicating energy was being fed to the battery for charging. During the active cycle, the battery current jumped to about-1 mA, indicating that energy was instead being drawn from the battery. After completion of the active cycle, the battery current returned to a value over 0.5 mA and slowly returned to its original value as charging of the battery completed by around record number 100.

### REFERENCES

U.S. Pat. Nos. 7,692,411, 9,786,910, 10,553,861, 10,566,620, 10,700,349, 10,978,704, 10,978,731, 11,165,090, 11,283,267, 11,302,912, 11,469,417, 11,482,752, 11,581,536, 11,641,014, 11,658,281, 11,942,803, 11,962,004, 11,973,224, 12,009,508, and 12,087,901.

U.S. Patent Application Publication No. 2024/0097478.
Borah et al., 2020, “On battery materials and methods,” Materials Today Advances 6, 2020, 100046, DOI: 10.1016/j.mtadv.2019.100046
Becker et al., 2021, “Energy Harvesting for a Green Internet of Things,” Power Sources Manufacturers Association (PSMA) white paper, ISBN 978-1-7337815-2-7

### Statements Regarding Incorporation by Reference and Variations

All references throughout this application, for example patent documents, including issued or granted patents or equivalents and patent application publications, and non-patent literature documents or other source material are hereby incorporated by reference herein in their entireties, as though individually incorporated by reference.

All patents and publications mentioned in the specification are indicative of the levels of skill of those skilled in the art to which the invention pertains. References cited herein are incorporated by reference herein in their entirety to indicate the state of the art, in some cases as of their filing date, and it is intended that this information can be employed herein, if needed, to exclude (for example, to disclaim) specific embodiments that are in the prior art.

When a group of substituents is disclosed herein, it is understood that all individual members of those groups and all subgroups and classes that can be formed using the substituents are disclosed separately. When a Markush group or other grouping is used herein, all individual members of the group and all combinations and subcombinations possible of the group are intended to be individually included in the disclosure. As used herein, “and/or” means that one, all, or any combination of items in a list separated by “and/or” are included in the list; for example “1, 2 and/or 3” is equivalent to “1, 2, 3, 1 and 2, 1 and 3, 2 and 3, or 1, 2, and 3”.

Every formulation or combination of components described or exemplified can be used to practice the invention, unless otherwise stated. Specific names of materials are intended to be exemplary, as it is known that one of ordinary skill in the art can name the same material differently. It will be appreciated that methods, device elements, starting materials, and synthetic methods other than those specifically exemplified can be employed in the practice of the invention without resort to undue experimentation. All art-known functional equivalents, of any such methods, device elements, starting materials, and synthetic methods are intended to be included in this invention. Whenever a range is given in the specification, for example, a temperature range, a time range, or a composition range, all intermediate ranges and subranges, as well as all individual values included in the ranges given are intended to be included in the disclosure.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition, in a description of a method, or in a description of elements of a device, is understood to encompass those compositions, methods, or devices consisting essentially of and consisting of the recited components or elements, optionally in addition to other components or elements. The invention illustratively described herein suitably may be practiced in the absence of any element, elements, limitation, or limitations which is not specifically disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

What is claimed is:

1. A system comprising:
an electrochemical energy storage device having a monotonic voltage profile and rechargeability in a range from 0.3 V to 1.5 V; and
an energy harvester that collects or is configured to collect energy from the environment and outputs a voltage in a range from 0.3 V to 1.5 V;
wherein the energy harvester is coupled to the electrochemical energy storage device to deliver energy collected by the energy harvester to the electrochemical energy storage device.

2. The system of claim 1, wherein the energy harvester comprises one or more of a photocell, a photovoltaic cell, a piezoelectric generator, an electromechanical generator, a thermoelectric generator, a pyroelectric generator, a field inductance transducer, a sound transducer, a pressure transducer, or other transducer capable of generating electrical energy from environmental conditions.

3. The system of claim 1, wherein the energy harvester is directly coupled to the electrochemical energy storage device.

4. The system of claim 1, wherein the energy harvester is coupled to the electrochemical energy storage device without any capacitor between the energy harvester and the electrochemical energy storage device or without any circuit component or device that includes a capacitor between the energy harvester and the electrochemical energy storage device.

5. The system of claim 4, wherein the energy harvester is indirectly coupled to the electrochemical energy storage device using one or more intervening circuit components.

6. The system of claim 1, wherein the electrochemical energy storage device does not exhibit a voltage plateau anywhere in the range of 0.3 V to 1.5 V.

7. The system of claim 1, wherein the voltage output by the energy harvester is less than a nominal or maximum voltage of the electrochemical energy storage device when fully charged.

8. The system of claim 1, wherein the voltage output by the energy harvester has a magnitude capable of charging the electrochemical energy storage device to less than 100% state of charge.

9. The system of claim 1, wherein the electrochemical energy storage device comprises a pseudocapacitor having the monotonic profile.

10. The system of claim 1, wherein the electrochemical energy storage device comprises a battery having the monotonic profile.

11. The system of claim 10, wherein the battery comprises a surface-functionalized acidified metal oxide nanomaterial as a cathode active material of the battery.

12. The system of claim 1, further comprising one or more components coupled to the electrochemical energy storage device, the one or more components comprising a voltage converter that generates an output voltage using a voltage of electrochemical energy storage device as an input, a processor or other logic device, an output capacitor for stabilizing the output voltage, a standby load, a switch, or an output load.

13. The system of claim 12, wherein the voltage converter is a boost converter exhibiting an input operating voltage in the range of 0.3 V to 1.5 V.

14. The system of claim 12, wherein the energy harvester is sized with a capacity that does not exceed 100% of the standby load and the transmission load together.

15. The system of claim 12, wherein the standby load corresponds to or comprises a continuously active circuit, a sensor, a monitoring circuit, a feedback circuit, a control circuit, a clock circuit, a processor or processing function, or any combination of these.

16. The system of claim 12, wherein the output load corresponds to or comprises a periodically active or discontinuously active circuit, a wireless transmitter, a wireless transceiver, a wireless receiver, or any combination of these.

17. The system of claim 12, wherein the output load, when active, exhibits a larger power consumption than the standby load.

18. The system of claim 12, wherein the energy harvester comprises a limiting circuit or wherein the system further comprises a limiting circuit positioned between the energy harvester and the electrochemical energy storage device, the limiting circuit including one or more components for limiting the voltage output by the energy harvester or for preventing the energy harvester from overcharging the electrochemical energy storage device.

19. The system of claim 12, wherein the output load is configured to be active on a repeated basis to avoid overcharging the electrochemical energy storage device.

20. A method comprising:
collecting energy using an energy harvester, wherein the energy harvester outputs a voltage of 0.3 V to 1.5 V; and
charging an electrochemical energy storage device using energy collected by the energy harvester, wherein the electrochemical energy storage device exhibits a monotonic voltage profile and rechargeability in a range of 0.3 V to 1.5 V.
